(19) United States
(12) Patent Application Publication
(10) Pub. No.: US 2008/0041669 A1
(43) Pub. Date: Feb. 21, 2008

(54) Directing Passengers Using Color Indications

(75) Inventors: Frank Sansevero, Glastonbury, CT (US); Zuhair S. Bahjat, Farmington, CT (US); Harold Terry, Avon, CT (US); Richard Pulling, Avon, CT (US); Daniel James Stillion, Woodside, CA (US); Kate M. Schreiber, Cambridge, MA (US); Gregg Robert Draudt, Stow, MA (US); Jared Alden Judson, Topsfield, MA (US)

Correspondence Address: CARLSON GASKEY & OLDS, 400 W MAPLE STE 350, BIRMINGHAM, MI, 48009, US

(73) Assignee: OTIS ELEVATOR COMPANY, FARMINGTON CONNECTICUT (US)

(21) Appl. No.: 11/573,796

(22) PCT Filed: Oct. 5, 2004
(86) PCT No.: PCT/US04/32786

§ 371 Date: Aug. 28, 2007

(51) Int. Cl. B66B 1/16

(52) U.S. Cl. 187/389

(57) ABSTRACT

An elevator system (20) includes a controller (22) that communicates with a portable device (30) that is adapted to be carried about by a passenger (32). The system provides a color indication (28A-28E) associated with an elevator car (26A-26E) that will travel to a passenger's intended destination floor. In one example, the portable device (30) provides a color indication that corresponds to the color indication (28A-28E) associated with the car. Providing the color indication (34) on the portable device (30) assists a passenger (32) in locating the correct car and provides piece of mind to the passenger that they are entering the correct car and will be carried to their intended destination floor.

### FIELD OF THE INVENTION

This invention generally relates to elevator systems. More particularly, this invention relates to directing passengers to elevator cars using color indications.

### DESCRIPTION OF THE RELATED ART

Elevator systems sometimes have a plurality of cars that carry passengers between different levels within a building. In many public buildings there are lobby levels where many or all of the elevator cars can be accessed to travel to higher floors. Recent developments include providing so-called destination entry systems where a passenger enters a destination floor and then is assigned to a particular elevator car. Various techniques for assigning passengers to particular cars are known.

It is also known to provide hand-held signaling devices that allow an individual to enter a destination selection without requiring the individual to press a call button, for example. U.S. Pat. No. 5,689,094, which was issued on Nov. 18, 1997, shows one example arrangement where destination calls can be entered using a transmitter that can be carried about by an individual.

Another arrangement is shown in the published application US 2001/0035314. In that document, hall call touch screens can change between an up/down arrow mode and a destination entry mode.

Even with such advances, there are difficulties associated with destination entry systems. The ability to handle high volumes of passenger traffic during peak uptimes, for example, makes destination entry systems attractive from an efficiency standpoint. There are hesitancies among passengers, however, because most are not accustomed to approaching an elevator car without having pressed an up or down call button in the immediate vicinity of the car, for example. Various ways of directing passengers from a destination entry location to an appropriate car have been proposed. Shortcomings of such systems include requiring passengers to remember a particular letter or number that indicates the car to which they have been assigned.

There is a need for an improved way of directing passengers to appropriate cars especially when a destination entry type of elevator control arrangement is used. This invention meets that need while avoiding the shortcomings and drawbacks of previous attempts.

### SUMMARY OF THE INVENTION

In general terms, this invention includes directing passengers to elevator cars by providing a color indication near the car responsive to a destination input from a portable device that is adapted to be carried by the passenger.

One example method includes providing a corresponding color indication on the portable device.

In one example, the method includes determining the intended destination responsive to an input from the passenger. In one example, this includes receiving a passenger input from the portable device using wireless communication signals. Once the appropriate car has been determined and an associated color indication is determined, the same color indication is provided on the portable device so that a passenger has a visual guide to direct them to the appropriate car. With the portable device in hand, the passenger is able to confirm that they are entering the correct car right at the time they are entering the car, which removes any fear of getting on a car that will not take them to their intended destination.

In one example system, a display is provided within the car that displays the same color, displays the floors that will be serviced by the car and the direction of travel of the car. Such a display within the car provides a further confirmation to a passenger and alleviates any concerns associated with entering a car that does not have a traditional car operating panel that allows an individual to select a particular floor button while they are in the car.

The various features and advantages of this invention will become apparent to those skilled in the art from the following detailed description of the currently preferred embodiments. The drawings that accompany the detailed description can be briefly described as follows.

### BRIEF DESCRIPTION OF THE DRAWINGS

FIG. 1 schematically illustrates selected portions of an elevator system that includes an embodiment of this invention.

FIG. 2 schematically illustrates one example portable signaling device designed according to an embodiment of this invention.

FIG. 3 schematically illustrates another example portable signaling device designed according to an embodiment of this invention.

FIG. 4 schematically illustrates a display that can be used within a car, for example, to provide confirmation to a passenger entering that car.

### DETAILED DESCRIPTION OF THE PREFERRED EMBODIMENTS

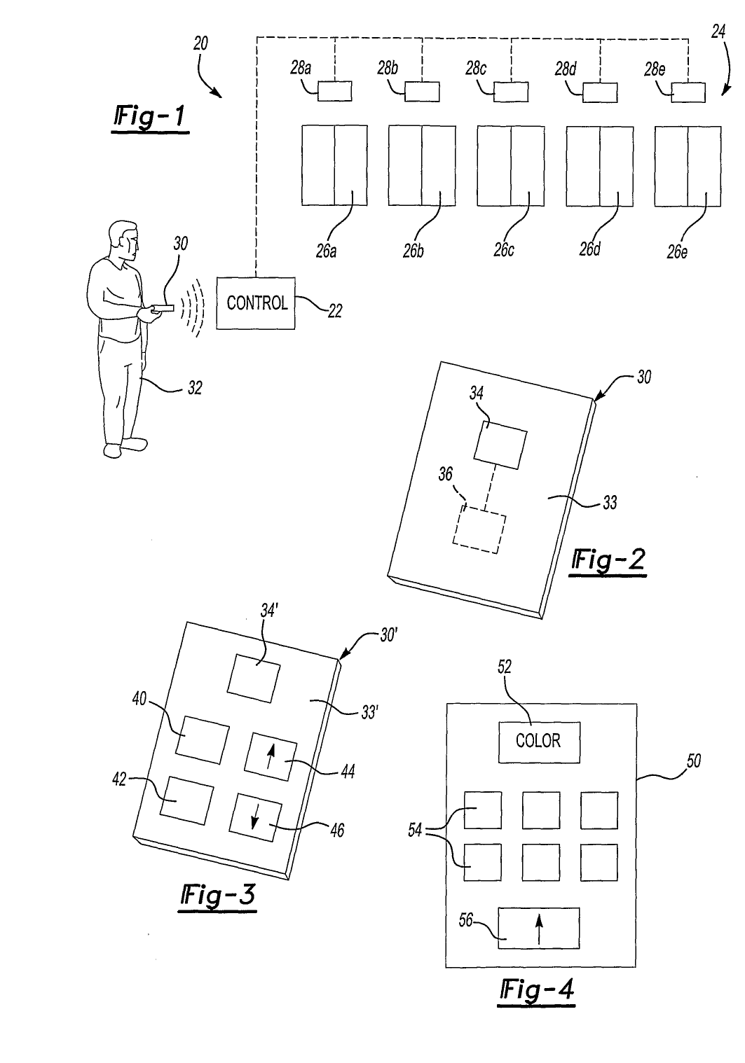

FIG. 1 schematically illustrates selected portions of an elevator system 20. A system controller 22 operates in a known manner to direct cars to appropriate floors to carry passengers to their intended destinations. In this example, a building lobby 24 includes a plurality of elevator cars 26A-26E that are available to passengers for traveling to different levels within a building. An indicator 28A-28E is associated with each car and in this example is shown above the entrance to each car at the lobby level. The indicators 28A-28E in this example provide a visible indication of a color. Various display techniques can be used to provide the color indication so that it is visible to passengers in the lobby 24.

In one example, the controller 22 uses a known sector assignment technique for assigning cars to particular floors. In this example, the controller 22 includes at least a portion in communication with a destination entry device 29 that is remote from the entrance to the cars 26A-26E. A passenger enters an intended destination floor at the destination entry device 29. The controller 22 determines which car that passenger will be taking to the intended destination (based upon a current sector assignment, for example). The controller 22 also determines a color for the display 28A-28E associated with the corresponding car. The color indication on the appropriate display directs the passenger to the proper car. Communicating the color to the passenger may be accomplished in at least one of several ways. Various examples are described below.

As schematically shown in FIG. 1, a portable device 30 can be carried about by a passenger 32. In this example, the portable device 30 is capable of transmitting wireless signals to the destination entry device 29 for communicating with the controller 22 to provide the indication of the passenger's intended destination. The portable device 30 includes a color indication display portion that responds to the controller 22 and provides a visible color indication for the passenger 32 that corresponds to the color indication associated with the car that will take the passenger to the intended destination floor.

FIG. 2 shows one example portable device 30 that is embodied as a card. The card has a body 32 that can be made of plastic, for example. A color indication display portion 34 provides a visible color indication to the passenger. The displayed color indication corresponds to the color indication associated with the car that will travel to the passenger's intended destination floor.

In this example, the device 30 includes a transceiver portion 36 that operates in a known manner to wirelessly communicate through radio frequency signals, for example, with the system controller 22 in a passive manner. That is, in this example, the device 30 does not require any manual activation by the user. Simply having the card 30 within a selected range of the destination entry device 29 allows the controller 22 to process a signal from the transceiver 36 indicating the passenger's intended destination floor. The transceiver 36 can also receive a signal from the controller 22 that indicates the color that should be displayed on the display portion 34. Such wireless communication techniques are known.

In another example, shown in FIG. 3, a portable device 30′ includes a plastic body 32′ that supports a color indicator display portion 34. This example includes a plurality of manually activatable switches 40-46. In this example, the switch 40 may be dedicated to a usual destination floor of the passenger so that on a normal day they can press the switch 40 to provide their intended destination indication to the controller 22. Upon receiving an appropriate signal, the controller 22 communicates with the device 30′ so that the appropriate color indication is provided on the display portion 34. In this example, another switch 42 allows the individual to override the normal destination (i.e., they may need to travel to a different floor on a particular day compared to a normal day). The illustrated example also includes switches 44 and 46 to indicate up or down hall call buttons choices when the individual is on a floor other than a main floor such as a lobby floor that includes a specific destination entry device.

In one example, the up and down switches 44 and 46 are used in conjunction with the switch 42 to enter a selected destination floor. For example, the override switch 44 can be activated which displays a floor number in the display portion 34. The up and down arrow switches 44 and 46 can be used to increase or decrease that floor and then the switch 42 can be pressed again to provide a signal to the controller 22 indicating what floor the passenger intends to visit.

There are a variety of known techniques for providing a color indication on a portable device such as those illustrated in FIGS. 2 and 3. In one example, a multi-color LED is used and illuminated to show a visible indication of a color corresponding to the color on the display 28A-28E adjacent the appropriate car.

In another example, the destination entry device 29 displays colors associated with particular floors or groups of floors so that a passenger will know what color indicates a proper car even if that passenger does not have a portable device that displays a color indication. In another example, color assignments for selected floors or sectors are displayed in a manner that an individual can discern which car will carry them to their intended destination without manually entering a call (i.e., by using a hall call button or a button on a destination entry kiosk in a lobby).

FIG. 4 schematically illustrates a feature of one example embodiment. A display 50 is provided within each of the cars 26A-26E. The display 50 includes a color indication portion 52 and a floor indicator 54. There is also an indicator 56 that shows the direction of travel of the car. In one example, the display 50 operates responsive to a control portion (not illustrated) that determines when the portable device 30 is present within the car. Upon detecting the presence of a device and determining a corresponding entered destination floor, the floor indicator 54 will show that floor number to provide a passenger a visible confirmation that they are on the correct car going to their intended destination floor. The color indication 52 and the direction indication 56 also provide confirmation and peace of mind to a passenger that they have, in fact, entered the correct car.

Providing a color indication associated with the entrance to a car and on a portable device that can be carried about by a passenger ensures that an individual will be confident that they are entering an appropriate elevator car to reach their intended destination. Providing the color indication on a portable device allows the passenger to use a destination entry device at a location that is remote from the actual entry to the elevator car. Having corresponding color indications near the car and on the portable device ensures that the passenger will not forget the color of their assigned car and alleviates concerns otherwise associated with using an elevator system that does not have traditional hall call buttons immediately adjacent the entrance to a car.

In one example, the controller 22 determines and changes the colors of the displays 28A-28E on an as-needed basis. For example, a sector assignment may change. In one example, the controller may change the color associated with a car that will carry a passenger who has previously received a color indication of their portable device 30. In this example, the controller communicates with such a passenger's portable device to make a corresponding change on the portable device display 34. In one example, a transmitter in the lobby communicates with corresponding portable devices 30 to make such a change as needed.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of directing a passenger to an elevator car that will carry the passenger to an intended destination, comprising the steps of:
receiving an indication of the intended destination from a portable device that is adapted to be carried by the passenger; and
providing a color indication near an entry to the car that will travel to the intended destination to thereby direct the passenger to the car.

2. The method of claim 1, including providing an indication within the car of at least one of the color indication, the intended destination or a direction of travel.

3. The method of claim 1, including
determining the intended destination;
determining at least one car that will travel to the intended destination;
determining a color indication associated with the determined car; and
providing a corresponding color indication using the portable device.

4. The method of claim 3, including communicating the determined color indication to the portable device using at least one wirelessly transmitted signal.

5. The method of claim 1, including providing a corresponding color indication using the portable device.

6. The method of claim 5, including illuminating a portion of the portable device such that a visible color on the illuminated portion is the corresponding color.

7. An elevator system, comprising:
at least one controller that communicates with a portable device adapted to be carried by the passenger to determine an intended passenger destination, determines a color indication associated with an elevator car that will travel to the intended passenger destination and directs the passenger to the car using the color indication.

8. The system of claim 7, wherein the portable device provides a corresponding color indication.

9. The system of claim 8, wherein the controller communicates the corresponding color indication to the portable device using at least one wirelessly transmitted signal.

10. The system of claim 7, including a destination entry device that receives passenger input regarding the intended destination from the portable device and wherein the controller uses the received passenger input to determine the intended destination.

11. The system of claim 7, wherein the controller provides an indication within the car of at least one of the color indication, the intended destination or a direction of travel responsive to determining that the portable device is in the car.

12. A portable destination entry device that is adapted to be carried by an elevator passenger, comprising:
a communication portion for communicating with an elevator system to provide an indication of an intended destination; and
an indicator portion that provides a color indication of a color corresponding to a color associated with an elevator car that will travel to the intended destination.

13. The device of claim 12, wherein the communication portion includes a transmitter that transmits at least one wireless signal indicating the intended destination.

14. The device of claim 13, including at least one switch for selectively generating the signal.

15. The device of claim 12, wherein the indicator portion is illuminated to provide the color indication.

16. The device of claim 12, including a receiver portion for receiving at least one signal from the elevator system indicative of the color indication.

17. The device of claim 12, comprising a card.

18. The device of claim 12, wherein the communication portion automatically provides a signal indicating the intended destination when the passenger enters the car.
